(19) United States
(12) Patent Application Publication
(10) Pub. No.: US 2004/0237330 A1
(43) Pub. Date: Dec. 2, 2004

(54) Rigid dryer duct adapter

(76) Inventor: Roger Stanley Fuller, St-Timothee (CA)

Correspondence Address: ROGER S. FULLER, 47 NOTRE DAME, ST-TIMOTHEE, QC, J6S 6A3, CA

(21) Appl. No.: 10/859,933

(22) Filed: Jun. 4, 2004

(30) Foreign Application Priority Data
May 29, 2003 (CA) 2,430,250

(51) Int. Cl. F26B 19/00

(52) U.S. Cl. 34/140

(57) ABSTRACT

A Rigid Dryer Duct Adapter, facilitating the connection of an exhaust system to a domestic clothes dryer in confined areas. The system comprising a flexible aluminised duct connected to a damper permanently installed through an exterior wall directing moist airflow out of a home.

One end of the rigid dryer duct adapter is connected to the exhaust pipe behind the dryer, its opposite end inserted into the flexible aluminised duct and held in place with a tie wrap.

A broom handle threaded at one end is screwed vertically into a special plastic attachment, which is an integral part of the rigid dryer duct adapter. A person standing, bending forward, looking behind the machine from the side can easily connect the rigid dryer duct adapter to the exhaust pipe. Once the adapter connected, unscrew and remove the broom handle then push the dryer back to its proper position.

### BACKGROUND OF THE INVENTION

1. Field of Invention

This invention relates to connecting an exhaust system to a domestic clothes dryer.

2. Description of the Prior Art

A domestic clothes dryer operating in a home drying damp clothes, warm moist air flows out from the exhaust vent pipe of the machine. For this air to reach the exterior of the building it needs an exhaust system connected to it. Flexible aluminised duct and sheet metal components are used to make up the exhaust system.

In most homes or apartments one usually finds machines to wash and dry clothes installed side by side in a restricted area, the dryer between a wall and a cabinet or in a closet. In these positions the back of the machines are not easily accessible for installation, maintenance or repairs. To carry out these tasks, one must pull the machines forward ninety centimetres or more, in this case a clothes dryer, in doing so the exhaust system is disconnected from the dryer, unplug the electrical cable from the wall receptacle or turn off the electric power for safety reasons. Repairs completed, one has to reconnect both systems using different options to accomplish these tasks.

The first option, in place a short flexible aluminised duct. Plug in the electric cable. Push the dryer towards the wall so that the flexible duct may reach the dryer. Lying on your stomach on the washing machine or cabinet, head down, squeeze your way in behind the clothes dryer and the wall, connect the exhaust duct to the dryer then work your way out.

The second option, in place a longer flexible aluminised duct. Plug in the electric cable. Push the dryer part way in towards the back wall, sit on the washing machine, swing your feet over the dryer and lower your feet to the floor. In a crouched position, connect the exhaust duct to the dryer then remove yourself from behind the dryer, repeating the way you entered.

The third option, you have to pull the clothes washing machine completely away from the wall. Push the dryer part way in, step in behind the washing machine, make the two connections for the dryer then step out and push both machines back to their proper positions.

### SUMMARY OF THE INVENTION

The aim of this invention is to facilitate the task of connecting an exhaust system to a domestic clothes dryer in confined areas. The second aim of this invention is to keep the exhaust system as short as possible. The third aim of this invention is to save time, energy and money.

This invention accomplishes these objects by providing an exhaust system of proper length that allows airflow from a domestic clothes dryer to reach the exterior of a house with very little restriction. It permits a person standing by the side of a dryer cabinet, which was pushed part way towards the back wall to easily install the adapter.

The exhaust system consists of a damper, a flexible aluminised duct and a rigid dryer duct adapter with one end crimped with a bead. When interconnected the exhaust system is one piece, the straight opposite end of the adapter fits perfectly over the dryer exhaust pipe.

My invention permits a person to use just the right length of flexible aluminised duct in the exhaust system. In turn, with little or no restriction to the airflow, the benefits derived are shorter drying times, less electrical energy is consumed and money is saved.

### DETAILED DESCRIPTION OF THE INVENTION

A rigid dryer duct adapter is fabricated with a short piece of galvanised light gauge sheet metal, rolled and spot welded to form a pipe, having a four inch inside diameter. With a special machine the crimping and the bead are produced at one end, the opposite end is straight.

On the sheet metal pipe a special threaded plastic attachment is held in place with two rivets.

To make this special plastic attachment a mould was machined, assembled with different ports and cavities. In production this mould is attached to a programmable moulding machine.

### DESCRIPTION OF THE DRAWINGS

FIG. 1 is a perspective view of the components that make up the exhaust system between a domestic clothes dryer and a damper to the exterior of a home.

FIG. 2 is an elevation view of the rigid dryer duct adapter.

FIG. 3 is a plan view thereof.

FIG. 4 is the end view thereof.

FIG. 5 is an elevation view of the plastic attachment.

FIG. 6 is an interior view thereof.

FIG. 7 is a plan view thereof.

### DESCRIPTION OF THE PREFERRED EMBODIMENTS

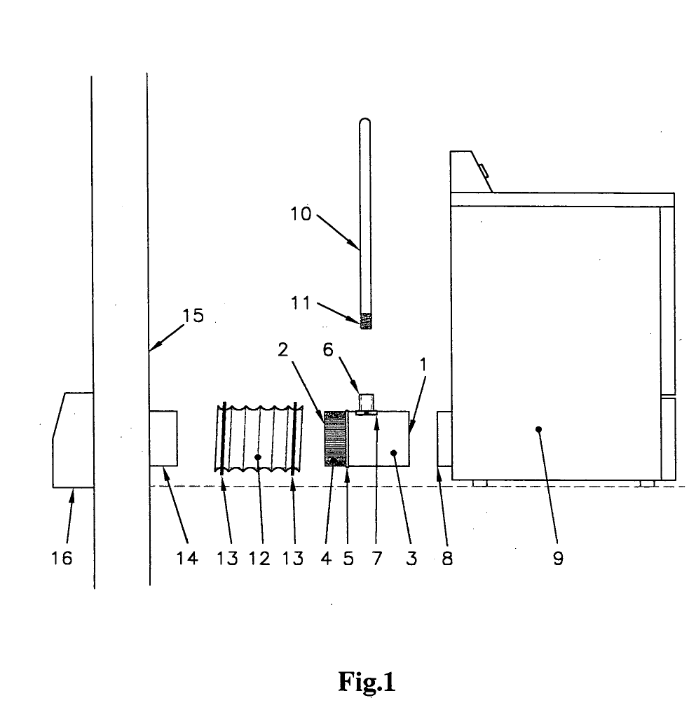

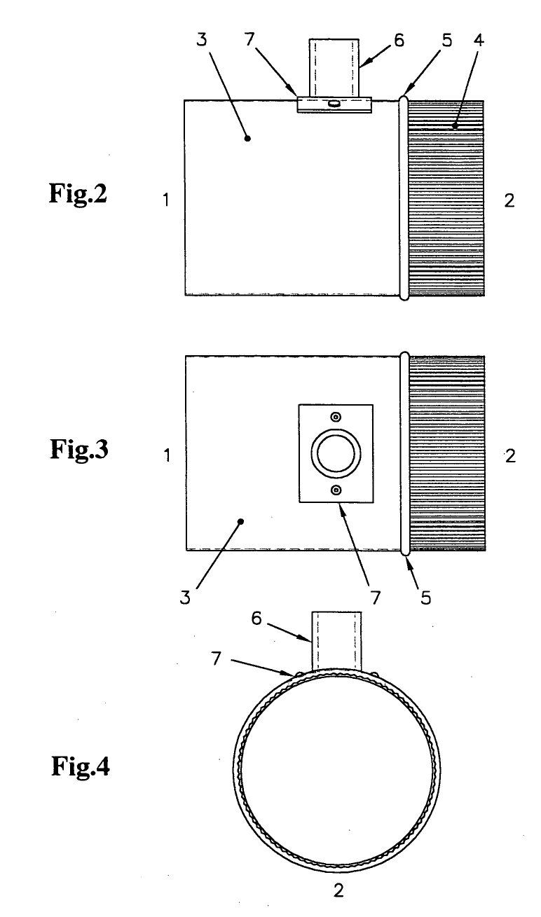

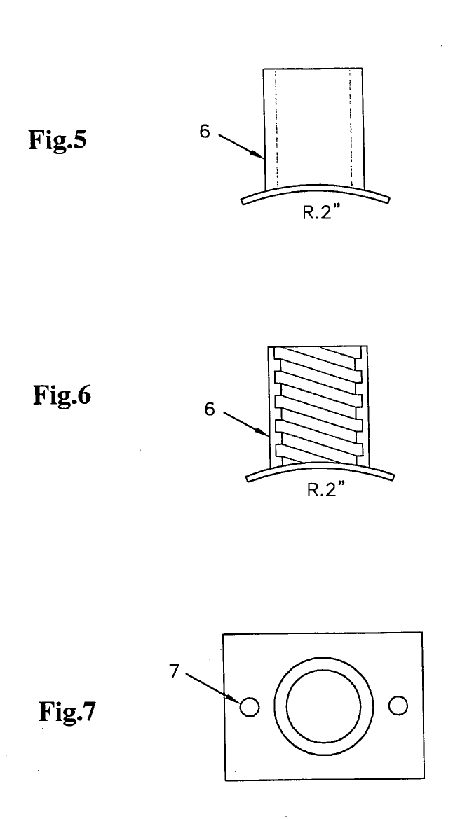

Referring now to FIG. 1, damper 16 permanently installed through the exterior wall of the house 15. The interior wall on pipe 14, a flexible aluminised duct 12, of proper length is slipped over it, then strapped in place with a tie wrap 13. End 2 of the rigid dryer duct adapter which is crimped 4 with a bead 5 is inserted into the opposite end of the aluminised flexible duct 12 held in place with a tie wrap 13. A broom handle 10 threaded at one 11 is screwed into the plastic attachment 6 attached to the sheet metal pipe 3 with two rivets 7. Making it easy to connect end 1 of the rigid dryer duct adapter to the exhaust pipe 8 behind the dryer cabinet 9.

The rigid dryer duct adapter, unique, very useful, can easily be installed by a resourceful person to complete a safe and efficient exhaust system for a domestic clothes dryer. The installation of the adapter into the flexible aluminised duct, a broom handle screwed into it vertically is all done in a free working environment. The dryer pushed part way towards the wall, the broom handle accessible to a person to complete the installation to the dryer. This invention can be used with different components, an elbow, long sheet metal pipes to modify the exhaust system should the need arise.

What I claim as my invention is a Rigid Dryer Duct Adapter, part of an exhaust system for directing moist airflow from a domestic clothes dryer to the exterior of a home.
In a domestic clothes dryer cabinet these essential components are found. Motor and fan, electric controls and heating elements. A horizontal rotating drum for clothes through which heated air is circulated in and out in rigid duct work within, directing through the rigid dryer duct adapter connected to a flexible aluminised duct of proper length and a damper sending the moist airflow to the exterior of the home. The rigid dryer duct adapter consists of:
Rigid dryer duct adapter having a predetermined length end 1 and 2.
End 1 adapted to connect the rigid dryer duct adapter over the exhaust pipe of the dryer.
End 2 fitted to connect the rigid dryer duct adapter into a flexible aluminised duct.
A broom handle threaded at one end is screwed vertically into the special plastic threaded attachment, which is an integral part of the rigid dryer duct adapter.

1. The rigid dryer duct adapter according to claim 1 is fabricated with galvanised sheet metal with a special moulded plastic attachment riveted to it.

2. The rigid dryer duct adapter according to claim 1 is straight with one end crimped with a bead.

3. The rigid dryer duct adapter according to claim 1 is connected horizontally to the dryer exhaust pipe.

4. The interior of the special attachment according to claim 1 is threaded.

5. The special plastic attachment according to claim 1 is positioned at an angle when connected to the dryer.

6. According to claim 1 it is less expensive to operate a domestic clothes dryer when there is little or no restriction to the airflow.

7. The broom handle, damper and the flexible aluminised duct are standard wares.
